(19) United States
(12) Patent Application Publication
(10) Pub. No.: US 2005/0187948 A1
(43) Pub. Date: Aug. 25, 2005

(54) Patient admission and information access system

(76) Inventors: Arnold Monitzer, Wayne, PA (US); Frank Heer, King of Prussia, PA (US); David Welch, Wilmington, DE (US)

Correspondence Address: Alexander J. Burke;5th Floor, Intellectual Property Department, 170 Wood Avenue South, Iselin, NJ, 08830, US

(21) Appl. No.: 10/796,865

(22) Filed: Mar. 9, 2004

Related U.S. Application Data
(60) Provisional application No. 60/542,077, filed on Feb. 5, 2004.

(51) Int. Cl. G06F 7/00

(52) U.S. Cl. 707/100

(57) ABSTRACT

A self-service system and user interface supports a patient in initiating, monitoring, and managing administration of admission, discharge and scheduling activity and in accessing medical information. A system supports patient access to medical information of the patient. The system includes an interface processor for receiving patient identification information and a database linking a patient identifier derived using the patient identification information, with prescription information identifying a medication for the patient. A data processor accesses the database to retrieve the prescription information. A display processor initiates generation of data representing an image including the prescription information, in response to the received patient identification information and a request by the patient to access the prescription.

### FIELD OF THE INVENTION

This invention concerns a system supporting patient self service access to healthcare data and functions.

### BACKGROUND OF THE INVENTION

In a hospital, a patient is prompted by personnel at an administration desk to provide or verify patient identification and personal information as well as insurance and physician information to support patient admission, discharge or transfer. An admissions, discharge or transfer process is typically labor intensive. It is desirable to reduce patient wait times and provide faster service with less staffing, e.g., by reducing the number of business office clerks that are required for a certain patient throughput. In existing systems a clerk is required to collect information and enter the information manually in the patient access system. This process requires resource intensive staffing to guarantee a minimum patient check-in or patient checkout throughput. Further, manual processes employed in existing systems impede increasing patient processing throughput and are vulnerable to error. Also it is desirable to provide a patient with electronic access to medical information such as prescription related information.

Existing known check-in or check-out administration systems are employed by hotel front desk applications, for example. However, such systems fail to provide a comprehensive complement of features and functions that support patient initiation, monitoring, expediting or management of admission, discharge and transfer activities occurring in hospitals and other healthcare facilities. Existing systems also fail to provide user access to his patient medical information through a user friendly interface supporting such features and functions in conjunction with an integrated healthcare information system. A system according to invention addresses these identified deficiencies and related problems.

### SUMMARY OF THE INVENTION

A self-service system and user interface supports a patient in initiating, monitoring, expediting and managing admission, discharge, scheduling and transfer administrative activity and in accessing medical information. A system supports patient access to medical information of the patient. The system includes an interface processor for receiving patient identification information and a database linking a patient identifier, derived using the patient identification information, with prescription information identifying a medication for the patient. A data processor accesses the database to retrieve the prescription information. A display processor initiates generation of data representing an image including the prescription information, in response to the received patient identification information and a request by the patient to access the prescription.

In a feature of the invention, the database links a patient identifier with a scheduled appointment to obtain healthcare services and the data processor accesses the database to determine the patient is scheduled for the appointment and validates patient eligibility for the healthcare services under a healthcare plan.

### BRIEF DESCRIPTION OF THE DRAWINGS

FIG. 1 shows a block diagram of a self-service system supporting a patient in initiating, monitoring, expediting and managing admission, discharge and transfer administration in a hospital and in accessing medical information, according to invention principles.

FIG. 2 shows a flowchart of process steps involved in patient self-service functions supported by the system of FIG. 1, according to invention principles.

FIG. 3 shows a flowchart of a process enabling patient access to medical information and monitoring and managing of admission and treatment related scheduling administrative activity, according to invention principles.

### DETAILED DESCRIPTION OF INVENTION

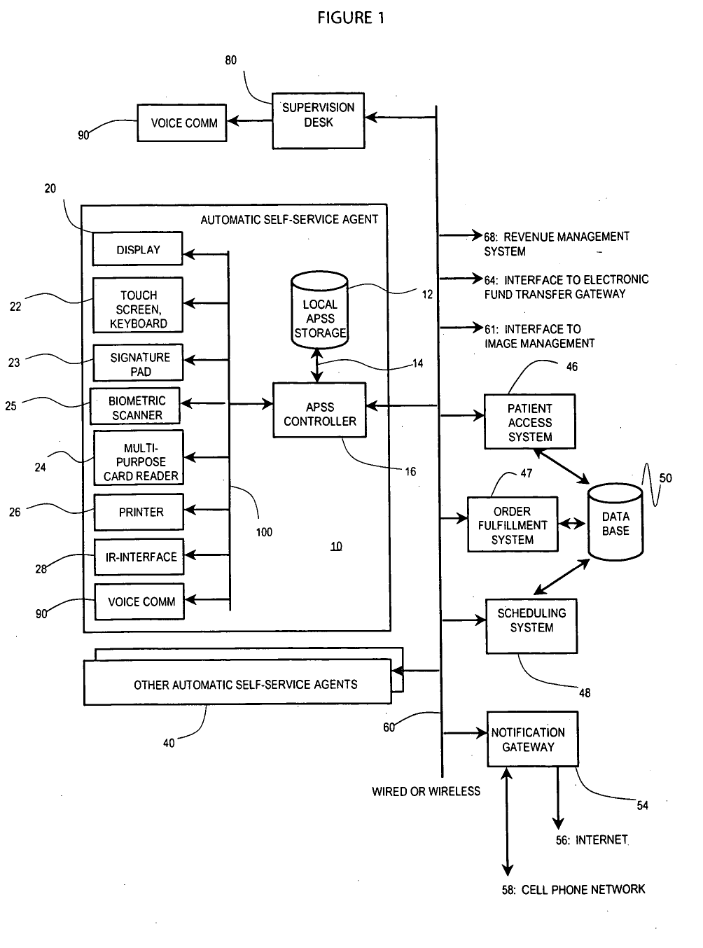

FIG. 1 shows a block diagram of a self-service system supporting a patient in initiating, monitoring, expediting and managing admission, discharge and transfer administration in a hospital and in accessing medical information. The system enables a patient to perform check-in and check-out steps by himself, guided by a user friendly interface. In contrast, existing systems fail to provide a sequence of tasks and operations (workflow) and necessary interfaces required in facilitating patient self service functions in an healthcare environment. Existing systems also fail to provide healthcare information executable applications and associated communication interfaces such as HL7 (HealthLevel 7) compatible interfaces to implement a comprehensive patient self service system suitable for use in the healthcare field. As used herein, a processor comprises any one or combination of, hardware, firmware, and software. A processor acts upon information by manipulating, analyzing, modifying, converting or transmitting information for use by an executable procedure or an information device, or by routing the information to an output device. A processor may use or comprise the capabilities of a controller or microprocessor, for example. Also, an encounter as used herein comprises a patient encounter with a healthcare enterprise involving patient and healthcare enterprise interaction that has a financial or transaction consequence and may include for example a patient visit, phone call, inpatient stay or outpatient treatment etc.

The FIG. 1 system includes an automatic patient self service agent (APSS) 10 that advantageously provides multiple communication interfaces supporting patient entry of information and access to medical information. The communication interfaces include an Infra-Red (IR) compatible interface 28 for a PDA (Personal Data Assistant) or handheld computer, and interfaces to a Patient Access function 46 and Scheduling function 48 of a healthcare information system. The interfaces to Patient Access function 46 and Scheduling function 48 (and other interfaces) may employ HL7 compatible protocol to provide services to a patient. The interface to patient scheduling function 48 enables a patient employing a user interface image on display 20 to automatically select a best available desired appointment time. APSS 10 provides a patient with automatic notification based on a communication method selected based on a patient location, a number of patients waiting and a status of patient service centers. Infrared (IR) interface 28 enables a patient PDA or handheld computer to download information (e.g., directions to a doctor's office, scheduling information, etc.) or to upload information such as contact information (address, etc). APSS 10 interfaces support automatic communication of appointment, test result, alert or other information and messages to a patient via a mobile device, pager or cell phone (e.g., using a short message service for GSM technology). via network 58 or the Internet 56 via network gateway 54, for example.

APSS 10 in one embodiment comprises a patient accessible terminal or kiosk, for example, that provides user interface images on display 20 and includes a multi-purpose card reader 24 that incorporates a magnetic strip reader, a chip-card reader and a barcode reader. The reader is able to read (a) credit card information, (b) debit card information, (c) driver license information, (d) health insurance card information as well as (e) patient medical record information on an electronic medium, for example. APSS 10 interfaces also include an integrated scanner of biometric information (finger print scanner, etc.) 25. APSS 10 further employs an automatic discovery function that searches for and interrogates other self-service desks connected to wired or wireless network 60.

Controller 16 is a master control unit of the APSS 10. Controller 16 communicates with local APSS storage 12 on bidirectional bus 14 to store and load information for the processing of self-service data. Controller 16 is connected via serial and parallel communication buses, wired or wireless 100 to I/O (Input/Output) devices 20-28 and 90. The controllers (16) of Multiple APSS 10 units can concurrently access a healthcare information system patient access function 46 or a scheduling function 48 via network 60. Controller 16 in communicating via network 60, employs Internet Protocol (IP), HL7, a proprietary protocol or other protocols such as the Open Systems Interconnect (OSI) protocol, e.g. X.25. Also controller 16 accesses data base 50 to validate and authenticate patient information.

Units 20-28 and 90 provide a user interface for use by a patient in performing self-service activities (e.g. check-in, check-out, review current insurance coverage, accessing medical information including a prescription, an appointments schedule, test results etc). Display 20 presents a patient with information or actions and tasks to be performed in order to proceed with a current self-service process. In a preferred embodiment, display 20 is integrated in a service kiosk or terminal with other user interface devices 22-28 and 90, for example. Alternatively, in another embodiment a patient may access medical information via the Internet and gateway 54. A user (e.g., a patient) is able to input text information via a touch screen or keyboard 22 integrated with display 20. A signature pad 23 is employed by a patient to enter signature confirmation in making an electronic payment using a credit or debit card for medication or services. Such a payment may be made during admission or discharge or in payment for medication indicated on a prescription, for example. A patient is also able to use signature pad 23 to sign documentation used in obtaining treatment such as a patient consent and HIPAA (Healthcare Information Portability and Accountability Act) compliance documents for electronic storage in imaging management system 61. In response to a patient payment, APSS 10 initiates an electronic fund transfer via electronic funds transfer system 64 and communicates information identifying the patient payment, to revenue management system 68.

Card reader 24 supports patient payment and patient identification verification by allowing APSS 10 to acquire information from different types of cards including cards employing magnetic, chip/IC or bar code technology, for example. Card reader 24 is used to acquire information from credit and debit cards, driver licenses, health insurance cards, patient specific medical information cards and electronic patient record storage devices, for example. In addition, controller 16 identifies a user based on identification information entered by the user (password, biometric scan, signature, chip card via various input devices 22, 23, 24, 25) in support of access authorization and payment authorization. Biometric scanner 25 is used to verify patient identification from fingerprints or retina scans etc. A patient is also able to employ printer 26 to print medical information in support of administration and treatment. A patient may employ APSS 10 and printer 26 to make a paper record to document information for a visit or other encounter including encounter number, schedule information, priority and directions or maps for a hospital location as well as referrals, bills, financial records, prescriptions for use by a patient in obtaining medication from a pharmacy and other records.

Infra-Red (IR) interface 28 (or other wireless interface e.g., an 802.11 compatible interface) enables a patient to wirelessly print or download information (e.g. represented in HTML page format) to a PDA, portable computing device or phone, for example. Controller 16 automatically schedules an appointment via network 60 in a patient calendar maintained by scheduling system 48 and sets an alert time period prior to the scheduled time. Controller 16 communicates a message at the alert time period prior to the scheduled appointment via gateway 54 to notify the patient of the scheduled appointment. A mobile device connected to Internet 56 retrieves a notification message. Alternatively, a message service is used to forward a notification message to a cell phone 58. A notification message alerts a patient that he should return, e.g. within the next 15 minutes, to a waiting room or that a prescription order is fulfilled and ready for collection, for example. The notification gateway 54 receives information identifying a geographic location of the cell phone (or other mobile device or pager, for example) and estimates an alert time period for notification. The time period is computed in response to the cell phone location and a time delay determined based on a current number of patients waiting and a number of service centers able to provide service, for example. APSS 10 employs scheduling system 48 in scheduling follow-up appointments at hospitals or doctors offices. Further, APSS 10 is not restricted to healthcare use but may also be used to extend functions of public service offices, (Drivers license offices, Social Security offices, etc), restaurants, hotels and for other applications.

A supervision desk 80 comprises a computing device that enables a business office clerk to monitor automatic self service agents 10, 40. The clerk provides help and advice to a patient using integrated speaker and microphone voice communication unit 90 if a patient signals a problem has been encountered in using APSS 10. Unit 90 employs voice over IP compatible communication protocol to support voice communication between units 10 and 80. Controller 16 and supervision desk 80 advantageously execute an auto-discovery procedure that automatically discovers other self-service agents 40 and provides online status monitoring by supervision desk 80.

APSS 10 in another embodiment comprises a mobile or portable device that continues to operate when it is disconnected from network 60. APSS 10 operates via a wireless connection to network 60. Alternatively, APSS 10 operates entirely disconnected from network 60 by storing acquired and processed information in local storage 12 for subsequent transmission upon re-connection to network 60 via a wireless or wired connection. A portable APSS 10 is useable in an emergency ambulance or mobile intensive care unit, for example.

APSS 10 advantageously supports dialog with a patient that is controlled by the patient. Card reader 24 and interface 28 enable automatic acquisition of information from patient related cards and portable devices to reduce error prone manual interaction (such as text typing). APSS 10 also updates patient information (such as demographic information, telephone number, etc) retained in patient access system 46. Further, APSS 10 interfaces to scheduling system 46 via network 60 and seamlessly integrates with the systems managing sequences of tasks comprising the workflow of a hospital, care facility, therapy center, physician practice or other healthcare facility. APSS 10 provides automatic patient notification via gateway 54, cell phone network 58 and Internet 56 (e.g., by e-mail, pager or cell phone), to inform a patient of a scheduled appointment or of an available appointment in an emergency room priority schedule. An automatic notification is advantageously sent at a time prior to a scheduled appointment. The time the notification is sent is determined in response to current geographic location of a portable processing device or a geographic location of a pager or cell phone in a network. APSS 10 may also be a portable device (operating in a networked mode or in an offline mode) used in ambulances for collection of required check-in information on the way to the hospital, for example. APSS 10 operates in cooperation with supervision desk 80 supporting voice communication to APSS 10 embodied as a self service kiosk (or in other embodiments as a portable unit or a user accessible terminal accessed in a hospital or in a users home, for example). The voice communication employed by supervision desk 80 uses existing network infrastructure and IP over Ethernet.

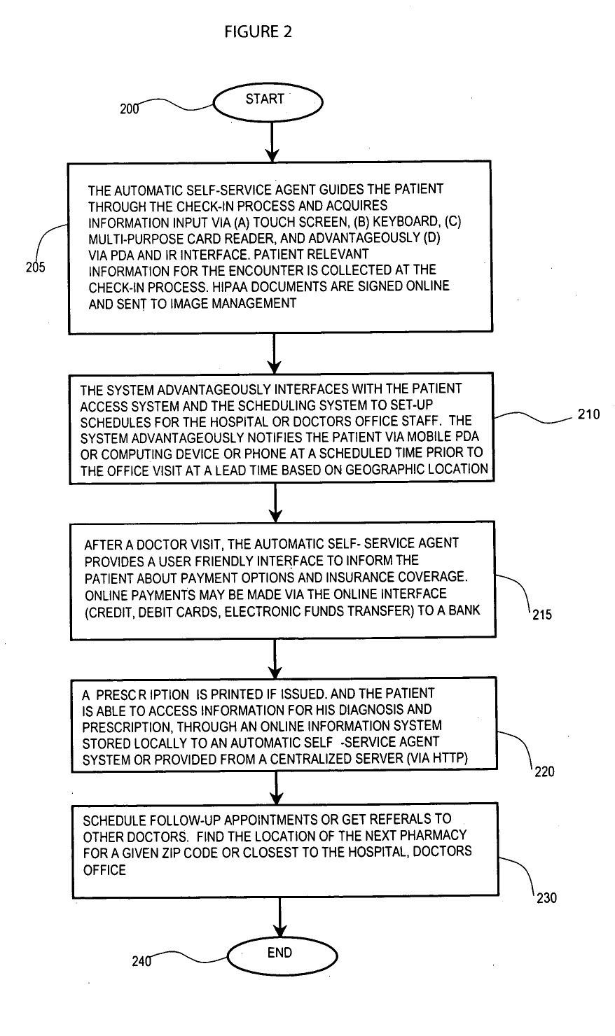

FIG. 2 shows a flowchart of process steps involved in patient self-service functions supported by the system of FIG. 1. In step 205 following the start at step 200, APSS 10 generates a user interface image on display 20 including information guiding a patient through an admission process and acquires patient entered information input via a keyboard or other data entry device such as a touch screen or card reader 24 or information provided via IR interface 28 or network 60 from a portable device. APSS 10 acquires information related to the patient encounter associated with the admission process as well as signed documents for HIPAA compliance. APSS 10 also acquires treatment procedure authorization and other documents for storage in image storage system 61. In step 210, APSS 10 schedules tasks for healthcare workers including clinician and administrative personnel via interfaces to scheduling system 48 and patient access system 46. APSS 10 also notifies the patient by communicating an alert message at a time determined in response to a mobile device geographic location prior to the scheduled appointment. The alert message is communicated to a mobile device such as a phone, PDA or laptop, for example,

In step 215, APSS 10 provides a user friendly interface via display 20 to inform a patient about payment options and insurance coverage following a patient visit. APSS 10 supports on-line payment by visa card or electronic funds transfer using car reader 24 and electronic funds transfer and revenue management systems 64 and 68 respectively or by using gateway 54 and Internet 56, for example. APSS 10 in step 220 also enables a patient to access diagnosis information, an issued prescription, fulfillment status of an ordered prescription or other medical information for presentation on display 20 or printing on printer 26. This information may also be acquired from a remote server or database connected to network 60 or via the Internet 56. APSS 10 accesses prescription and prescription status related information using fulfillment system 47 and database 50. Controller 16 links patient data acquired from patient access system 46 with prescription and order fulfillment status acquired from order fulfillment system 47 indicating the completion of preparation of a prescription. Controller 16 receives this information via network 60 and displays it via unit 20 to the user. The estimated time to fulfillment of a prescription (that is the time to wait until an order is complete), is determined based on content of a medication inventory as well as a current number and type of orders awaiting preparation indicated by records in database 50. The estimated time to fulfillment of a prescription is also accessed and displayed by the controller 16 via display 20. Controller 16 also interfaces with Revenue Management system 68 for acquiring healthcare insurance plan information. This information, including covered cost, and co-pay and claim and other information is also accessible by a patient for viewing on display 20.

In step 230, APSS 10 enables a user, via display 20, to schedule a follow-up appointment, initiate obtaining a referral to another physician or to find a location of a pharmacy (e.g., in a particular zip code or nearest a hospital or other address). The process of FIG. 2 terminates at step 240.

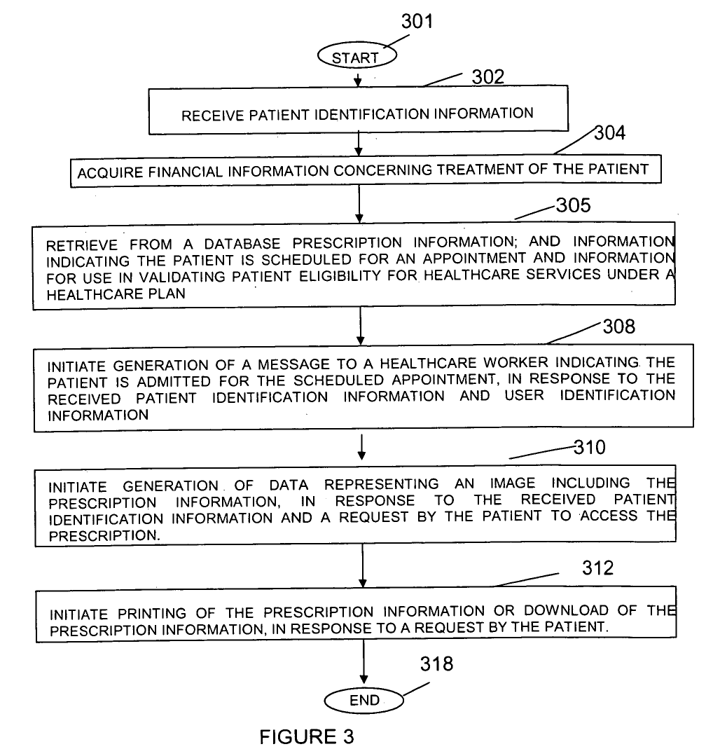

FIG. 3 shows a flowchart of a process enabling patient access to medical information and monitoring and managing of admission and treatment related scheduling administrative activity. In step 302 following the start at step 301, APSS 10 receives patient identification information. APSS 10 in step 304 acquires financial information including healthcare insurance plan information provided by a healthcare payer organization and patient incurred costs of obtaining a prescription. The healthcare insurance plan information concerns particular medications approved under a healthcare insurance plan and cost of medications approved under a healthcare insurance plan. Further, the patient incurred costs of obtaining a prescription are automatically pre-populated into a form supporting, (a) reimbursement for the costs or (b) tax determination. APSS 10 also initiates presentation of forms to a user on display 20. The forms include pre-populated patient specific information, for capturing patient entered information.

In step 305, APSS 10 accesses database 50 (including other distributed databases as required) to determine the patient is scheduled for an appointment and retrieves information items from database 50 for processing and presentation to a user via display 20. Database 50 (including other distributed databases or repositories as required) associate a patient identifier, with, (a) a scheduled appointment to obtain healthcare services, (b) prescription information identifying a medication for the patient, (c) order fulfillment data indicating completion of preparation of the prescription and (d) information for use in validating patient eligibility for a particular healthcare service under a healthcare plan. APSS 10 derives a patient identifier using the received patient identification information and also validates patient eligibility to receive healthcare services under a healthcare plan and automatically initiates processing of referral information provided by a patient's physician to support a scheduled visit.

In step 308, APSS 10 initiates generation of a message to a healthcare worker indicating the patient is admitted for a scheduled appointment or indicating completion of preparation of a prescription. For this purpose, APSS 10 retrieves prescription order fulfillment data from database 50. In step 310 APSS 10 initiates generation of data representing one or more images including the detailed prescription description information, data indicating completion of preparation of the prescription, healthcare insurance plan information, patient incurred costs of obtaining the prescription, information validating patient eligibility for healthcare services under a healthcare plan or referral information provided by a patient physician to support a scheduled visit, in response to received patient identification information and a request by the patient to access prescription or other information. APSS 10 in step 312 initiates printing of the prescription information or download of the prescription information, in response to a request by the patient. Similarly, APSS 10 initiates download or printing of any other information in database 50, in response to patient request. The process of FIG. 3 terminates at step 318.

The system and processes presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to invention principles enables a patient to monitor, expedite and manage admission, discharge, scheduling and transfer administrative activity and to access medical information. Further, any of the functions provided by APSS 10 (FIG. 1) may be implemented in hardware, software or a combination of both and may reside on one or more processing devices located at any location of a network linking the FIG. 1 elements or another linked network including another intra-net or the Internet.

1. A system supporting patient access to medical information of said patient, comprising:
an interface processor for receiving patient identification information;
a database linking a patient identifier derived using said patient identification information, with prescription information identifying a medication for said patient; and
a data processor for accessing said database to retrieve said prescription information; and
a display processor for initiating generation of data representing an image including said prescription information, in response to said received patient identification information and a request by said patient to access said prescription.

2. A system according to claim 1, wherein
said database links said patient identifier with order fulfillment data indicating completion of preparation of said prescription,
said data processor accesses said database to retrieve said prescription order fulfillment data; and
said display processor initiates generation of data representing an image including said order fulfillment data.

3. A system according to claim 1, wherein
said database comprises a plurality of databases.

4. A system according to claim 1, including
an acquisition processor for acquiring healthcare insurance plan information concerning at least one of, (a) medications approved under a healthcare insurance plan and (b) cost of medications approved under a healthcare insurance plan, said healthcare insurance plan being provided by a healthcare payer organization and
said display processor initiates generation of data representing an image including said healthcare insurance plan information.

5. A system according to claim 1, including
an acquisition processor for acquiring financial information comprising patient incurred costs of obtaining said prescription and
said display processor initiates generation of data representing an image including said patient incurred costs of obtaining said prescription.

6. A system according to claim 5, wherein
said patient incurred costs of obtaining said prescription are automatically pre-populated into a form supporting at least one of, (a) reimbursement for said costs and (b) tax determination.

7. A system according to claim 1, including
a biometric identification device for validating patient identification.

8. A system according to claim 1, wherein
said database links said patient identifier with a scheduled appointment for said patient to obtain healthcare services; and
said data processor accesses said database to determine said patient is scheduled for said appointment and for validating patient eligibility for said healthcare services under a healthcare plan and initiating generation of a message to a healthcare worker indicating said patient is admitted for said scheduled appointment, in response to said received patient identification information.

9. A system according to claim 1, including
an access processor for initiating at least one of, (a) printing of said prescription information and (b) download of said prescription information, in response to a request by said patient.

10. A system supporting patient self service admission to a healthcare provider organization to obtain healthcare services, comprising:
an interface processor for receiving patient identification information;
a database linking a patient identifier, derived using said patient identification information, with a scheduled appointment to obtain healthcare services; and
a data processor for accessing said database to determine said patient is scheduled for said appointment and for validating patient eligibility for said healthcare services under a healthcare plan and initiating generation of a message to a healthcare worker indicating said patient is admitted for said scheduled appointment, in response to said received patient identification information.

11. A system according to claim 10, including
a repository for linking said patient identifier with prescription information identifying a medication for said patient; and
a display processor for initiating generation of data representing an image including said prescription information retrieved from said repository, in response to a request by said patient to access said prescription.

12. A system according to claim 10, wherein said database includes said repository.

13. A system according to claim 10, wherein
said interface processor acquires said patient identification information from a card reader device reading a patient specific electronic identification card.

14. A system according to claim 10, wherein
said interface processor initiates presentation of a form to a user via an image display for capturing patient entered information, said form including pre-populated patient specific information.

15. A system according to claim 10, wherein
said data processor automatically initiates processing of referral information provided by a patient physician to support said scheduled visit.

16. A system according to claim 10, including
a communication processor providing bidirectional communication via a network between said data processor and a patient record system and a scheduling system.

17. A system according to claim 16, wherein
said communication processor provides said bidirectional communication using HealthLevel 7 (HL7) protocol.

18. A system according to claim 10, wherein
said database and said repository comprise at least one of, (a) the same repository and (b) a plurality of different repositories.

19. A system according to claim 10, including
a biometric identification device for validating patient identification.

20. A system supporting patient self service admission to a healthcare provider organization to obtain healthcare services, comprising:
an interface processor for receiving patient identification information;
at least one database linking a patient identifier, derived using said patient identification information, with a scheduled appointment to obtain healthcare services and with prescription information identifying a medication for said patient;
a data processor for accessing said at least one database to determine said patient is scheduled for said appointment and initiating generation of a message to a healthcare worker indicating said patient is admitted for said scheduled appointment, in response to said received patient identification information; and
a display processor for initiating generation of data representing an image including said prescription information retrieved from said repository, in response to a request by said patient to access said prescription.

21. A system according to claim 20, wherein
said at least one database links said patient identifier with order fulfillment data indicating completion of preparation of said prescription,
said data processor accesses said database to retrieve said prescription order fulfillment data; and
said display processor initiates generation of data representing an image including said order fulfillment data.

22. A method supporting patient access to medical information of said patient, comprising the activities of:
receiving patient identification information;
associating a patient identifier derived using said patient identification information, with prescription information identifying a medication for said patient; and
accessing said database to retrieve said prescription information; and
initiating generation of data representing an image including said prescription information, in response to said received patient identification information and a request by said patient to access said prescription.

23. A method supporting patient self service admission to a healthcare provider organization to obtain healthcare services, comprising the activities of:
receiving patient identification information;
associating a patient identifier, derived using said patient identification information, with a scheduled appointment to obtain healthcare services; and
accessing said database to determine said patient is scheduled for said appointment and for validating patient eligibility for said healthcare services under a healthcare plan and initiating generation of a message to a healthcare worker indicating said patient is admitted for said scheduled appointment, in response to said received patient identification information.

24. A method supporting patient self service admission to a healthcare provider organization to obtain healthcare services, comprising the activities of:
receiving patient identification information;
associating a patient identifier, derived using said patient identification information, with a scheduled appointment to obtain healthcare services and with prescription information identifying a medication for said patient;
accessing said at least one database to determine said patient is scheduled for said appointment and initiating generation of a message to a healthcare worker indicating said patient is admitted for said scheduled appointment, in response to said received patient identification information; and
initiating generation of data representing an image including said prescription information retrieved from said repository, in response to a request by said patient to access said prescription.
